(19) United States
(12) Patent Application Publication
(10) Pub. No.: US 2013/0084649 A1
(43) Pub. Date: Apr. 4, 2013

(54) FLUORESCENCE MEASUREMENT

(71) Applicants: Barry Colin Crane, Shennington (GB); John Gilchrist, Helensburgh (GB); Neil Cairns, Paisley (GB)

(72) Inventors: Barry Colin Crane, Shennington (GB); John Gilchrist, Helensburgh (GB); Neil Cairns, Paisley (GB)

(73) Assignee: LIGHTSHIP MEDICAL LIMITED, London (GB)

(21) Appl. No.: 13/579,247

(22) PCT Filed: Feb. 15, 2011
(86) PCT No.: PCT/GB2011/000210

§ 371 Date: Nov. 21, 2012

Related U.S. Application Data
(60) Provisional application No. 61/306,362, filed on Feb. 19, 2010.

(51) Int. Cl. G01N 21/64

(52) U.S. Cl. CPC G01N 21/6486
USPC 436/501; 422/69

(57) ABSTRACT

A sensor for fluorescence measurement comprising: a light source arranged for emitting light to a sample region, wherein the light source intensity is modulatable; an indicator system located at the sample region, said indicator system comprising: a receptor for an analyte; and a fluorophore associated with said receptor, wherein the fluorophore has a fluorescence lifetime that changes in response to the presence of analyte at the receptor; a single photon avalanche diode arranged to receive fluorescence light emitted from said sample region in response to the light incident on the sample region from the light source, and to generate an output signal; a driver arranged to modulate the light source intensity at a first frequency; a bias voltage source arranged to apply a bias voltage to the single photon avalanche diode, wherein the bias voltage is modulated at a second frequency, different from the first frequency, and wherein the bias voltage is above the breakdown voltage of the single photon avalanche diode; and a signal processor arranged to determine information related to a fluorescence lifetime of the fluorophore based on at least the output signal of the single photon avalanche diode.

### FIELD OF THE INVENTION

The present invention relates to a sensor and method for measuring fluorescence of a sample, for example for measuring fluorescence lifetime or for measuring a property of a sample that is related to fluorescence lifetime.

### BACKGROUND TO THE INVENTION

Fluorescence measurement, particularly measurement of fluorescence lifetimes, is of considerable practical importance in photo-chemistry and photo-physical research. More recently, there has been interest in utilizing fluorescence lifetime measurements for sensor applications. However, there are considerable practical difficulties, such as the low intensity of the fluorescence light, both in absolute terms and relative to the intensity of the excitation light. Furthermore, the fluorescence lifetimes of interest, for example in glucose sensing applications, may be extremely short, such as of the order of 10 ns.

There are two principal methodologies for fluorescence lifetime measurement: time-domain and frequency-domain. Each method, in principle, obtains the same results because they are related to each other via Fourier transforms.

Time-domain systems have mainly used the technique of time-correlated single photon counting using a pulsed laser, LED or nanosecond flash lamp as the excitation light source. The technique uses a time-to-amplitude converter to measure the time difference between start and stop pulse events (the start being the excitation pulse and the stop being the detection of a fluorescence photon). Essentially the system acts as a very fast stopwatch. Repeated pulse measurements build up a statistical representation of the decay curve of the fluorescent system.

An alternative time-domain approach is to use a so-called box-car averager system which requires a series of laser pulses of uniform intensity. This either means that the cost of the pulsed laser is high to achieve the high output stability; alternatively there is a compromise in signal-to-noise and therefore lower precision in the measurement. Furthermore, the peak power of the laser pulses can be very high resulting in photo-bleaching of the sample under investigation and therefore inaccuracy in the measured intensity of the fluorescence light.

The second approach is frequency-domain instruments which conventionally utilize a to modulated excitation light source. The measurement is made at a variety of modulation frequencies and the phase difference (or lag) is measured along with the change in the modulation depth of the received signal at each frequency. Conventional frequency-domain systems require power radio frequency (RF) circuits for the generation of the excitation modulation, if using pockels cells and xenon lamps, or laser systems. Photomultiplier detectors are typically used and also need to be modulated using similar power RF generators.

Thus conventional systems for fluorescence measurements are large, cumbersome, have high power requirements, and generally require specialist operators to set up and perform the measurements and obtain useful results.

There are therefore problems in making compact, inexpensive, low-power devices that are simple to use, for example for use in homes or clinics for applications such as medical monitoring, for example of glucose levels in diabetic patients.

### SUMMARY OF THE INVENTION

The present invention provides a fluorescence sensor comprising:
a light source arranged for emitting light to a sample, wherein the light source intensity is modulatable;
an indicator system located at the sample region, said indicator system comprising: a receptor for an analyte; and a fluorophore associated with said receptor, wherein the fluorophore has a fluorescence lifetime that changes in response to the presence of analyte at the receptor;
a single photon avalanche diode arranged to receive fluorescence light emitted from said sample region in response to the light incident on the sample region from the light source, and to generate an output signal;
a driver arranged to modulate the light source intensity at a first frequency;
a bias voltage source arranged to apply a bias voltage to the single photon avalanche diode, wherein the bias voltage is modulated at a second frequency, different from the first frequency, and wherein the bias voltage is above the breakdown voltage of the single photon avalanche diode; and
a signal processor arranged to determine information related to a fluorescence lifetime of the fluorophore based on at least the output signal of the single photon avalanche diode.

Preferably the analyte sensor is a glucose sensor.

Also provided is a method of fluorescence sensing comprising:
emitting light to a sample region from a light source, wherein the sample region comprises an indicator system comprising: a receptor for an analyte; and a fluorophore associated with said receptor, wherein the fluorophore has a fluorescence lifetime that changes in response to the presence of analyte at the receptor;
receiving fluorescence light, emitted from said sample region in response to the light incident on the sample region from the light source, using a single photon avalanche diode, and generating an output signal;
modulating the light source intensity at a first frequency;
applying a bias voltage to the single photon avalanche diode, wherein the bias voltage is modulated at a second frequency, different from the first frequency, and wherein the bias voltage is above the breakdown voltage of the single photon avalanche diode; and
determining information related to a fluorescence lifetime of the fluorophore based on at least the output signal of the single photon avalanche diode.

Preferably the analyte is glucose.

According to a preferred embodiment, the light detector is a single photon avalanche diode. The intensity of light emitted by the light source is modulated at a first frequency, and the bias voltage applied to the single photon avalanche diode is modulated at a second frequency, different from the first frequency. The bias voltage is above the breakdown voltage of the single photon avalanche diode. This selection of bias voltage means that the single photon sensitivity of the detector is maintained, but also has the advantage that a heterodyne measurement approach can be used. In other words, the resulting measurement signal of interest from the single photon avalanche diode is at a frequency corresponding to the difference between the first and second frequencies. The first and second frequencies may be of the order of 1 MHz or much higher, but may be selected such that their difference is, for example, of the order of 10 s of kHz. Therefore, the operational bandwidth of the measurement electronics can be much lower than the first and second modulation frequencies, allowing a simpler design and with less sensitivity to noise.

A further advantageous aspect is to introduce a series of additional phase angles (or time delays equivalent to phase shifts) in the modulation signal for the light source. A series of measurements can then be obtained relating the modulation depth of the measurement signal to the introduced phase angle. Analysing these results can improve the overall precision of the fluorescence lifetime measurement.

### BRIEF DESCRIPTION OF THE FIGURES

FIG. 1 depicts schematically a fluorescence sensor of the invention;

FIG. 2 is a flowchart of an analyte concentration measurement method according to a preferred embodiment of the invention; and

FIG. 3 is an illustration of a glucose sensing system according to an embodiment of the invention.

### DETAILED DESCRIPTION OF THE INVENTION

The present invention provides a sensor and measurement method for fluorescence measurements. A preferred embodiment relates to the measurement of glucose concentration, as will be described in more detail below. Firstly, the general arrangement and operation of the fluorescence sensor will be explained.

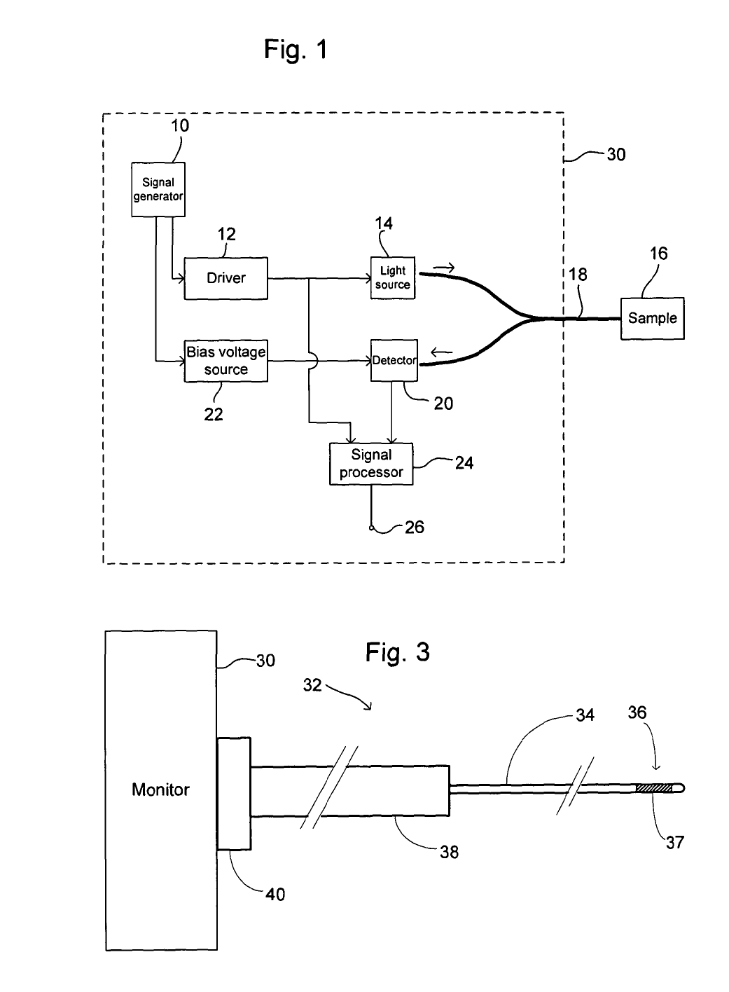

FIG. 1 shows schematically an embodiment of a fluorescence sensor according to the invention. A signal generator 10 produces a high frequency periodic signal at a first frequency that is passed to a driver 12. The driver 12 may condition the first signal and then uses it to drive modulation of a light source 14. The light source 14 generates the excitation light to be used for stimulation of the fluorescence system being investigated. The light source 14 can be, for example, an LED or laser diode. Preferably the light source 14 is temperature stabilized. The choice of output wavelength of the light source is made to suit the sample under investigation to stimulate a transition in the sample. The term “light” is not intended to imply any particular restriction on the emission wavelength of the light source, and in particular is not limited to visible light. The light source 14 may include an optical filter to select a wavelength of excitation, but this filtering may be unnecessary if the light source has a sufficiently narrow band or is monochromatic.

The driver 12 drives the light source 14 to modulate the intensity (amplitude) of the excitation light. Preferably this is done by the driver 12 electrically modulating the light source to vary the emission intensity. Alternatively, the light source 14 may include a variable optical modulator to change the final output intensity. The shape (waveform) of the modulation of the intensity of the light from the light source 14, controlled by the signal generator 10 and the driver 12, may take various forms depending on the circumstances, including sinusoidal, triangular or pulsed, but the modulation is periodic at the first frequency.

The light output from the light source 14 is transmitted to the sample 16 located at a sample region. In FIG. 1, an optical fiber 18 is used, and appropriate couplers (not shown) are used to couple the light into and out of the optical fiber 18. However, the transmission can be made by alternative means, such as other forms of waveguide or free-space optics.

The sample 16 under investigation is not restricted to any particular phase, and could be, for example, a solid or an aqueous solution. A specific example would be a fluorophore in contact with blood containing glucose for glucose monitoring. The sample 16 can be in a discrete sample cell, or, in one preferred embodiment, is provided intimately in or on the distal end of an optical fiber 18. The sample under investigation absorbs some of the excitation light received from the light source 14 and very shortly afterwards emits fluorescence light, typically at a longer wavelength. If the light source 14 were to emit a single pulse, then the intensity of the emitted fluorescence light would exhibit an exponential decay, and the half-life of this decay would give the fluorescence lifetime. However, because the output of the light source 14 is periodically modulated, then the fluorescence light is also modulated in nature at the same fundamental first frequency. However, there is a time delay introduced in the fluorescence emitted light because of the fluorescence behaviour of the sample 16; this manifests itself as a phase delay between the modulation of the excitation light and the modulation of the fluorescence light.

In one embodiment of the invention, the fluorescence signal may be temperature corrected. In this embodiment, a thermocouple (thermistor or other temperature probe) (not shown) is located at the sample.

The emitted fluorescence light is transmitted to a detector 20, again using free space optics or a waveguide such as an optical fiber. In the embodiment shown in FIG. 1, the optical fiber 18 includes a splitter to direct some of the fluorescence light to the detector 20. An optical filter (not shown) may be provided to restrict the wavelengths of light that can reach the detector 20, for instance to block substantially all light except that at the fluorescence wavelength of interest. The detector 20 is a single photon avalanche diode (SPAD) (a type of photodiode); suitable SPADs include SensL SPMMicro, Hamamatsu MPPC, Idquantique ID101, and other similar devices. (A single-photon avalanche diode may also be known as a Geiger-mode APD or G-APD; where APD stands for avalanche photodiode.) The single photon avalanche diode detector 20 can be either the kind having a low breakdown voltage (threshold) or a high breakdown voltage. A bias voltage is applied to the single photon avalanche diode detector by a bias voltage source 22, such that the bias voltage is above the breakdown voltage of the single photon avalanche diode. In this state the detector 20 has very high sensitivity such that receipt of a single photon causes an output current pulse, and thus the total output current is related to the received light intensity, even when the intensity is very low.

The bias voltage source 22 receives a periodic signal at a second frequency from the signal generator 10 such that the bias voltage applied to the single photon avalanche diode detector 20 is modulated at that second frequency. In the preferred embodiment, the single photon avalanche diode detector is a low voltage type and the mean bias voltage is in the region of 25 to 35 Vdc, but may be higher or lower depending on the actual device breakdown voltage, with a modulation depth of typically 3 to 4 V at the second frequency. The waveform of the modulation, like that of the light source, is not limited to any particular form, but is typically sinusoidal. The output of the detector 20 is passed to a signal processor 24. An analogue-to-digital converter (ADC) (not shown) can be provided so that the analogue output signal of the single photon avalanche diode is converted to the digital domain and the signal processor 24 can employ digital signal processing (DSP).

The modulation of the bias voltage modulates the gain of the single photon avalanche diode detector 20. The light source 14, and hence the received fluorescence light are modulated at a first frequency, but the bias voltage of the single photon avalanche diode detector 20 is modulated at a second frequency, different from the first frequency. This enables a heterodyne measurement approach to be used by the signal processor 24 operating on an analysis signal at a frequency equal to the difference between the first frequency and the second frequency. This enables the operational bandwidth of the measurement electronics to be reduced, for example using a lower frequency ADC and lower frequency signal processor 24. This permits simpler and cheaper electronics to be used with less susceptibility to noise. Preferably the first and second frequencies differ by less than 10% such that the signal processing electronics 24 can operate at less than a tenth of the modulation frequency of the light source. More preferably, the frequency difference is less than 1%.

According to another embodiment, the first and second frequencies can be nominally the same, but a varying phase shift is introduced between the signals (for example by delaying one signal with respect to the other, by a delay that continuously varies). As the phase shift changes each cycle, this is in fact the same as having two different frequencies. Preferably the introduced phase shift is swept rapidly.

The signal processor 24 can be implemented in dedicated electronic hardware, or in software running on a general purpose processor, or a combination of the two. In a preferred embodiment, a microprocessor (not shown) controls both the signal processor 24 that performs the analysis, and the signal generator 10. Thus the signal processor 24 has information on the light source modulation signal frequency and phase, and the detector bias voltage modulation frequency and phase.

The required modulation frequency of the light source is governed partly by the desired measurement precision, and partly by the shortest fluorescence lifetime required to be measured, which depends on the sample and so is not arbitrarily selectable. In one example, the first frequency (frequency of modulation of the light source intensity) is 1.00 MHz, and the second frequency (frequency of modulation of the bias voltage modulating the gain of the single photon avalanche diode detector 20) is 1.05 MHz. The difference frequency is therefore 50 kHz and this is the frequency of the analysis signal that needs to be processed. The signal generator 10 can comprise a single high frequency oscillator, the output of which is passed through different frequency divider circuits to generate the signals at the first and second frequencies. The first and second frequencies may be changeable, as required for the particular measurement being undertaken.

From the signal being analysed, and knowing the frequency and phase of both the modulation of the light source 14 and of the modulation of the detector bias voltage, the signal processor 24 could, in principle, determine the phase delay introduced into the system, part of which is as a result of the sample 16. However, each component in the system also introduces a time or phase delay. Therefore, firstly a measurement is done either without any sample present or with a sample of known fluorescence lifetime (known phase delay). From this, the intrinsic delays in the electronic and optical system can be obtained, represented by a phase angle associated with this delay. This provides an instrumental calibration. Next, the sample under investigation is introduced and the sample fluorescence alters the phase of the system. This change in phase, relative to the intrinsic phase shift of the instrument must be purely due to the sample. Knowing the phase shift resulting from the sample, information related to the fluorescence lifetime can be determined. For example, knowing the phase and the modulation frequency of the light source 14, then the fluorescence lifetime itself can be directly obtained. However, for sensor applications, the fluorescence lifetime is not actually the final desired output. Instead, the parameter being measured affects the fluorescence lifetime, and hence the phase delay. From the phase delay, the value of the parameter being measured can be obtained, for example by calculation using a mathematical relationship, or by obtaining a value from a look-up table. The required measurement result is then presented at output 26. The output measurement result can be displayed on a display (not shown) and/or can be logged in a memory (not shown) for later retrieval.

The above-described method essentially uses a single data point to derive the desired fluorescence-related information. However, according to a further preferred embodiment of the invention, a series of measurements are performed with the sample 16 present, but for each measurement a different phase shift and/or frequency difference is electronically introduced such that the phase angle can be controllably advanced or retarded. The two signal waveforms generated by the signal generator 10 are at the first and second frequencies that are different from each other, such that the relative phase of the signals at these frequencies will vary with time. However, the apparatus is in control, so that, for example, the waveforms at the two frequencies can be synchronised at a particular instant, and then the actual phase shift at any other time can be calculated. In one example, measurements are repeated with shifts in the frequency difference of 10 kHz, 20 kHz and 30 kHz. In addition a specific phase shift can be introduced at the point of synchronisation, so that the waveforms have a known initial phase difference. For each introduced phase angle shift, the modulation depth of the signal being analysed is obtained in order to effectively map out the phase-modulation space. The introduced phase angle may be incremented for example in steps of 5 degrees from zero to 180 degrees. The result is a series of data points that relate the modulation depths to the introduced phase angles. These data points constitute a graph that can be analysed e.g. by curve-fitting and/or comparison with calibration data of modulation depth relative to phase angle either with no sample present or with one or more standard calibration samples present. In general terms, results of measurements using different initial phase differences and/or different frequency differences can be aggregated, thus the overall measurement accuracy can be improved.

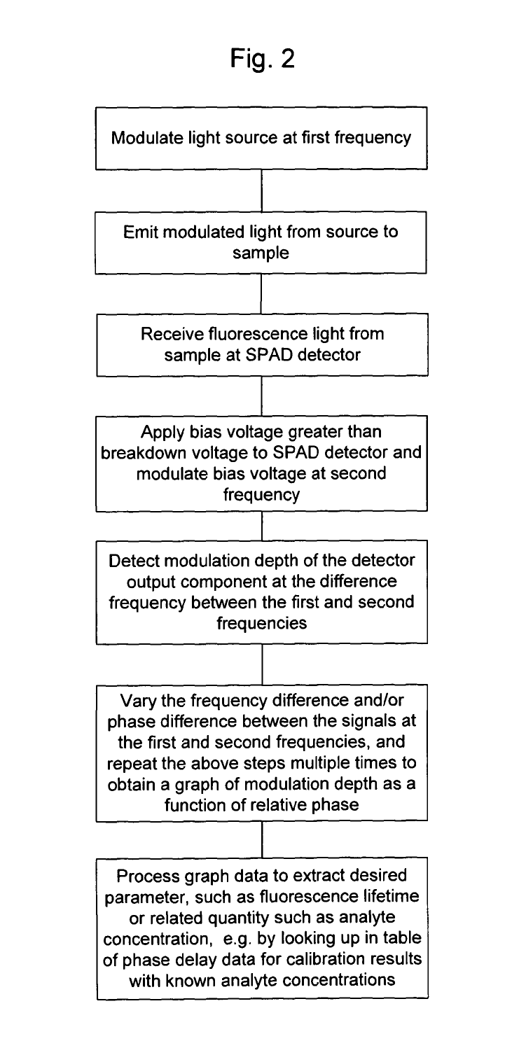

A summary of the method embodying the invention described above, is depicted schematically in the flowchart of FIG. 2.

The calibration data may be obtained contemporaneously with the measurements performed on the sample, or some or all of the calibration data may be obtained in advance and stored in a memory (not shown). The whole sensor apparatus can be controlled by a microprocessor (not shown). Although FIG. 1 shows a number of discrete electronic circuit items, at least some of these may be integrated in a single integrated circuit, such as a field-programmable gate array (FPGA) or application-specific integrated circuit (ASIC).

In addition to fluorescence lifetime measurement, the device is also capable of directly measuring the luminescence intensity from the sample 16 under single photon counting conditions. This can enable more powerful analysis of the sample by combining both lifetime and intensity measurements.

Although described above in terms of a single fluorescence lifetime, the sensor can, of course, simultaneously measure multiple fluorescence lifetimes, where the sample has more than one fluorescence emission.

The sensor of the invention can be used for quantitative measurement of the presence of an analyte if a suitable indicator system is provided for which the fluorescence lifetime changes in response to the presence of the analyte. An exemplary application of the invention will now be described in which the analyte is glucose. In this case, the “sample” comprises an indicator system comprising a receptor that selectively binds to glucose and a fluorophore associated with the receptor. Bodily fluid such as blood or interstitial fluid from a subject whose glucose level is to be measured, is introduced to the indicator system. On contact of any glucose in the fluid with the indicator system, binding occurs between the receptor and glucose molecules. The presence of a glucose molecule bound to the receptor causes a change in the fluorescence lifetime of the fluorophore. Thus, monitoring of the lifetime of the fluorophore in the indicator systems provides an indication of the amount of glucose which is bound to the receptor, and consequently can be used to measure the concentration of glucose in the bodily fluid.

Suitable receptors for glucose include compounds containing one or more, preferably two, boronic acid groups.

In the indicator system, the receptor is typically linked via one or more functional groups to the fluorophore and optionally to a support structure such as a hydrogel.

Examples of suitable fluorophores include anthracene, pyrene and derivatives thereof, for example the derivatives described in GB 0906318.1, the contents of which are incorporated herein by reference in their entirety. The fluorophore is typically non-metallic. Typically the fluorophore is non-endogenous. The lifetime of the fluorophore is typically 100 ns or less, for example 30 ns or less. Particular examples of suitable fluorophores are derivatives of anthracene and pyrene with typical lifetimes of 1-10 ns and derivatives of acridones and quinacridones with typical lifetimes of 10 ns-30 ns. According to some preferred embodiments, the lifetime is greater than 20 ns.

The receptor and fluorophore are typically bound to one another to form a receptor-fluorophore construct, for example as described in U.S. Pat. No. 6,387,672. This construct may further be bound to a support structure such as a polymeric matrix, or it may be physically entrapped within the probe, for example entrapped within a polymeric matrix or by a glucose-permeable membrane. A hydrogel (a highly hydrophilic cross-linked polymeric matrix such as a cross-linked polyacrylamide) is an example of a suitable polymeric matrix. In a preferred embodiment, a receptor-fluorophore construct is covalently bound to a hydrogel, for example via a functional group on the receptor. Thus, the indicator is in the form of a fluorophore-receptor-hydrogel complex.

In one preferred embodiment, the glucose sensor is used for in vivo glucose measurement. A sterile disposable probe is provided that includes a hollow metal needle for penetrating the skin. Apertures are provided for the bodily fluid to enter the probe where the indicator system is provided. An optical fiber may convey the excitation and fluorescence light to and from the indicator system within the probe, and indeed the indicator system may be attached at or on the end portion of the optical fiber.

Other components of the sensor can be provided integrally with the probe, or may be selectively connectable to the probe. The fluorescence data may be stored and periodically analysed to obtain the glucose information, or the glucose level may be continuously monitored.

A specific example of a glucose sensor system is shown in FIG. 3. A monitor unit 30 comprises the components indicated in the dashed box 30 in FIG. 1. Connected to the monitor 30 is a probe 32. The probe 32 comprises a tip 34 for insertion into a patient, for example by insertion into a blood vessel through a cannular. The tip 34 includes a sensing region 36 in which the glucose receptor-fluorophore indicator system 37 is positioned. The glucose receptor-fluorophore indicator system 37 is immobilised on or in the optical fiber, such that emitted fluorescence light is transmitted through the optical fiber. The optical fiber extends through cable 38 to connector 40, which is adapted to mate with the monitor unit 30. The monitor unit 30 includes further optical fiber that mates with the connector 40 at one end and at the other end bifurcates to connect to the light source and detector.

The sensing region 36 also optionally includes a temperature sensor (not shown). Electrical connection to the temperature sensor can be provided through the connector 40, and appropriate temperature detection equipment can be provided in the monitor 30.

The sensing region 36 of the probe 32 is typically coated with a membrane that allows diffusion of glucose from the surrounding fluid to the receptor-fluorophore. and, for in vivo use, is haemocompatible.

The invention has been described with reference to various specific embodiments and examples, but it should be understood that the invention is not limited to these embodiments and examples.

1. A fluorescence sensor comprising:
a light source arranged for emitting light to a sample region, wherein the light source intensity is modulatable;
an indicator system located at the sample region, said indicator system comprising: a receptor for an analyte; and a fluorophore associated with said receptor, wherein the fluorophore has a fluorescence lifetime that changes in response to the presence of analyte at the receptor;
a single photon avalanche diode arranged to receive fluorescence light emitted from said sample region in response to the light incident on the sample region from the light source, and to generate an output signal;
a driver arranged to modulate the light source intensity at a first frequency;
a bias voltage source arranged to apply a bias voltage to the single photon avalanche diode, wherein the bias voltage is modulated at a second frequency, different from the first frequency, and wherein the bias voltage is above the breakdown voltage of the single photon avalanche diode; and
a signal processor arranged to determine information related to a fluorescence lifetime of the fluorophore based on at least the output signal of the single photon avalanche diode.

2. A fluorescence sensor according to claim 1, wherein the first and second frequencies differ by less than 10%.

3. A fluorescence sensor according to claim 1, wherein the signal processor operates on a component of the output signal of the single photon avalanche diode at a frequency given by the difference between the first and second frequencies.

4. A fluorescence sensor according to claim 1, wherein a signal generator is controlled to vary at least one of: the frequency difference between said first and second frequencies; and the phase difference between signals at said first and second frequencies used to modulate the light source and modulate the bias voltage.

5. A glucose sensor comprising a fluorescence sensor according to claim 1, wherein the analyte is glucose.

6. A method of fluorescence sensing comprising:
emitting light to a sample region from a light source, wherein the sample region comprises an indicator system comprising: a receptor for an analyte; and a fluorophore associated with said receptor, wherein the fluorophore has a fluorescence lifetime that changes in response to the presence of analyte at the receptor;
receiving fluorescence light, emitted from said sample region in response to the light incident on the sample region from the light source, using a single photon avalanche diode, and generating an output signal;
modulating the light source intensity at a first frequency;
applying a bias voltage to the single photon avalanche diode, wherein the bias voltage is modulated at a second frequency, different from the first frequency, and wherein the bias voltage is above the breakdown voltage of the single photon avalanche diode; and
determining information related to a fluorescence lifetime of the fluorophore based on at least the output signal of the single photon avalanche diode.

7. A method according to claim 6, wherein the first and second frequencies differ by less than 10%.

8. A method according to claim 6, comprising determining the fluorescence lifetime information based on a component of the output signal of the single photon avalanche diode at a frequency given by the difference between the first and second frequencies.

9. A method according to claim 6, further comprising at least one of: varying the frequency difference between the first and second frequencies; and controlling the phase difference between signals at said first and second frequencies used to modulate the light source and modulate the bias voltage.

10. A method according to claim 6, wherein the analyte is glucose.

11. A method according to claim 6 , wherein the fluorescence lifetime is less than 100 ns, preferably less than 30 ns.
